(19) United States
(12) Patent Application Publication
(10) Pub. No.: US 2011/0306236 A1
(43) Pub. Date: Dec. 15, 2011

(54) "F" type electronic connector

(76) Inventors: James D'ADDARIO, Old Westbury, NY (US); Robert O. MILLER, Deer Park, NY (US)

(21) Appl. No.: 13/068,021

(22) Filed: Apr. 29, 2011

Related U.S. Application Data
(60) Provisional application No. 61/397,282, filed on Jun. 9, 2010.

(51) Int. Cl. H01R 9/05; H01B 13/20

(52) U.S. Cl. 439/578; 29/876

(57) ABSTRACT

A connector plug for attaching to a coaxial cable, by which the user strips the cable sheath through the jacket, braid, and dielectric, exposing a length of the signal conductor, and inserts the cable with exposed conductor into a hollow connector plug until the cut face of the cable abuts an insulator that is integral to the plug, and the signal conductor passes through a bore in the insulator. The insulator acts in place of the cable dielectric on a conventionally trimmed cable. An open faced “F” type nut is electrically connected to the body of the plug, forward of the insulator, and the exposed signal conductor extends through the nut. A screw on the plug body is then tightened, cutting through the jacket and making contact with the cable braid, thereby completing the ground connection between jacket and nut.

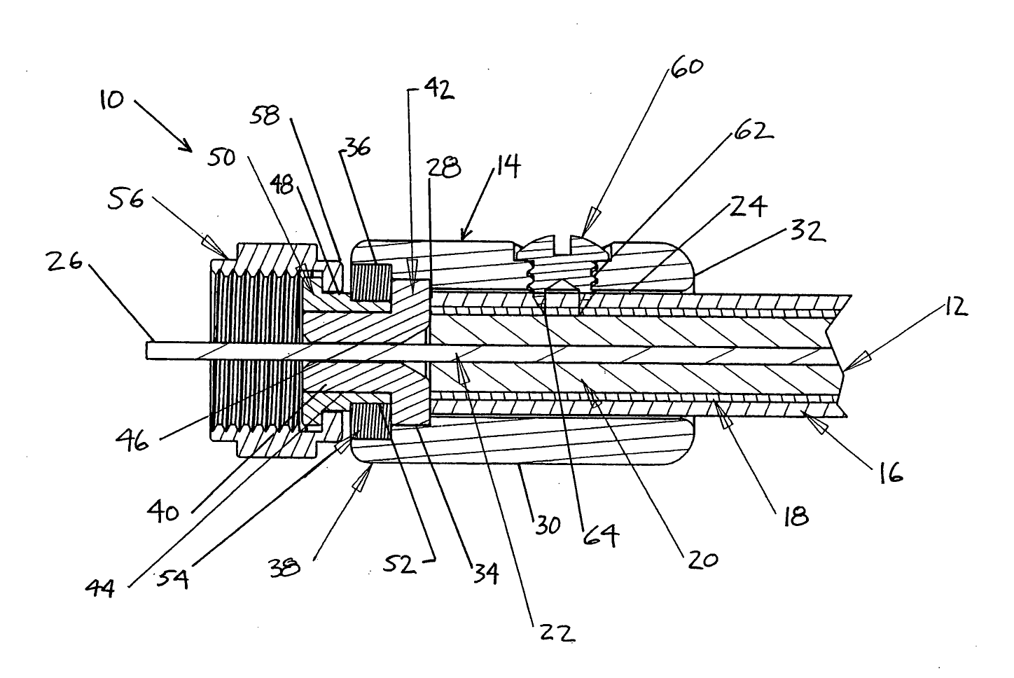

### BACKGROUND

The present invention relates to signal connectors for electronic equipment, especially audio-visual equipment.

Electronic signals for audio visual equipment are often transmitted along coaxial cables, and a male “F” type connector is commonly used on the output end of such cables for mating with a corresponding female “F” type jacks. For many end users, coaxial cable is purchased in a standard length which is desirably shortened for efficient use of space around the equipment. Also cable and satellite companies will install coax cable in homes to interconnect their incoming signal with television cable/satellite boxes, home theatre equipment, and recording equipment.

Conventionally, the cable jacket must first be stripped off the cable to a specific length, exposing the braided shielding, which in addition to preventing outside EMF or RFI noise entering the signal path, also acts as a ground or return for the circuit. Secondly, a portion of the braiding must be stripped away, again to a specific length, exposing the cable dielectric or insulator. This dielectric passes through the connector up to the point where the connector meets a matching insulator on the corresponding female “F” jack. This is necessary to ensure the integrity of the signal. At higher frequencies a break in this chain can cause degradation of the signal to the point that video and/or audio is lost either partially or entirely. Thirdly, a portion of the dielectric must be stripped away, again to a specific length, exposing the center, signal carrying conductor. This conductor then mates with a corresponding component in an “F” jack or receptacle once assembly is complete. At this point generally the connector is compressed or crimped onto the running cable.

Often, in practice, this crimp connection is incomplete or fails. The connector must then be discarded and the process repeated.

### SUMMARY

The present invention is directed to an improvement associated with cutting and trimming the output end of the cable and installing the connector onto the trimmed cable.

With the present invention, measuring of strip lengths for the various components of the cable construction and multiple stripping of the cable components are unnecessary.

According to the present disclosure, the user simply strips the cable sheath through jacket, braid, and dielectric, exposing the solid center conductor to some length greater than that needed to make a proper connection once the connector assembly is complete. The user inserts the cable with exposed conductor into the connector plug until the major diameter of the cable rests against an insulator that is integral to the connector. At this point the center conductor has passed through the insulator, which is acting in place of the cable dielectric on a conventionally trimmed cable. A screw on the plug body is then tightened, cutting through the jacket and making contact with the cable braid completing the ground connection. If necessary, the user then simply snips off, by eye, any excess of the exposed center conductor. The cable assembly is thus complete.

The invention is directed in one sense to a connector, in another sense to a connector assembly including coaxial cable, and in a third sense to a method of installing a connector to the output end of a coaxial cable. These variations all include the features that the connector has a hollow plug body, an insulator is secured in the forward end of the body, and an attachment nut is carried forward of the insulator. The cable is stripped with only one cut through the sheath, and inserted through the plug body. The back end of the insulator establishes a stop for the sheath of the trimmed cable, and has a central bore through which the central, signal conductor of the cable extends coaxially within and forward of the attachment nut.

This inventive technique has several unique advantages:
Multiple measuring and stripping actions are not required. Measuring and multiple stripping are both time consuming and considered quite tedious for the user. For the professional cable installer in particular, a savings in time directly converts to a monetary savings.
No special compression or crimping tools are required. Only a standard slot head screwdriver is required.
If the user makes a mistake, perhaps by cutting the cable too short for its intended use, the connector can be re-used.
The connector makes a more reliable ground connection via the screw in the plug body.

Although the features and advantages of the invention should be evident to practitioners in the relevant field upon reading the following description, the scope of exclusive rights sought to be patented is not limited to the embodiment described and shown. Rather, the scope of exclusive rights will be determined upon the filing and prosecution of a regular patent application based on the present provisional application.

### BRIEF DESCRIPTION OF THE DRAWING

The sole FIGURE is a longitudinal section view of an exemplary embodiment that incorporates the present invention.

### DETAILED DESCRIPTION

The FIGURE is a longitudinal section view of the preferred embodiment of the connector assembly 10, showing coaxial cable 12 secured within connector 14 in a condition ready for attachment to a jack of an electronic component (not shown). The cable 12 has an outer jacket 16 covering a braided shield 18 (ground conductor) which covers a dielectric insulator 20 which in turn covers the center conductor 22 (signal conductor). As is characteristic of “F” type connections, the jacket 16, shield 18, and dielectric 20 (which together can be referred to as the cable sheath) must be pre-trimmed for accommodation within the bore 24 of the connector 14 while the tip 26 of the signal conductor 22 extends forward.

A significant feature of the present invention is that the cable can be trimmed with only one cut through the sheath to the signal conductor 22, forming a squared off, annular front face 28 of the entire sheath before installation into the connector 14.

The connector 14 comprises a plug body 30 having a main bore 24 defining the longitudinal axis for receiving the cable 12 through the back end 32, and two counter bores 34, 36 at the front or forward end 38. An insulator 40 has a flanged base 42 in trailing counter bore 34, thereby closing the forward end of the main bore 24, and a cylindrical body 44 projecting forward of the base. The body 44 has a central bore 46 for accommodating passage of the front 26 of the signal conductor 22, preferably with a conical lead-in. A forward, nut bushing 48 surrounds at least a portion of the insulator body 44 and has an annular, radially outward shoulder 50 at the front and an annular groove 52 at the back. A ring bushing 54 is located between the front most or leading counter bore 36 of the body and groove 52 on the nut bushing 48.

An internally threaded nut 56 has an open front and a radially inward shoulder or annular projection 58 which is disposed behind outward should 50 on the nut bushing. The back portion 58 of nut 56 surrounds at least the axially extending, cylindrical body portion 44 of the insulator 40, which is rigidly secured to the forward end 38 of the plug body. The bushing 48 is interposed between the insulator 40 and the nut 56. The cooperation of projection 58 and shoulder 50 retains the nut 56 on the plug assembly 10 while permitting sufficient play over the bushing 48 to accommodate the rotation and axial displacement of the nut during installation and removal from the jack on the electronic equipment.

All the parts can be machined from brass or other rigid material, excepting the insulator 40, which can polymeric, such as polypropylene or other plastic, or other material. Different plastics have different properties when used as a dielectric (insulator). The geometry between the diameters of the center conductor 22 and insulator 40 has an effect on signal loss. The insulator material can thus be selected to provide optimum performance.

The following steps are employed to assemble the connector 14:

1. Insulator 40 is slip fit into the front 38 of the plug body 30, resting on a ledge created by the trailing bore 34.
2. Insulator retaining bushing 54 is press fit into the leading bore 36 on the body nose 38. This locks the insulator 40 in place between ledge and bushing.
3. The nut retaining bushing 48 slips past the threads of the nut 56, coming to rest on a smaller diameter shoulder or flange 58 at the base or back of the nut.
4. These two parts are then press fit onto the inside bore of the insulator retaining bushing 54.

The connector 14 as pre-assembled by the manufacturer can be sold with or without coaxial cable. The user trims and inserts the cable 12 through the bore 24 of the assembled connector until the sheath face 28 abuts the base 42 of the insulator 40, whereupon the screw 60 is advanced through threaded bore 62 in the plug body until the point 64 engages the cable shield 18. The point is preferably cup shaped with a sharp edge perimeter, and the overall length of the screw is designed to permit contact with the shielding 18 when the screw is fully advanced.

Inserting the cable until the sheath face 28 abuts the insulator 40 assures that the cable is well past the threaded bore 62 for the set screw 60, and that the front edge of the braided shield is in contact with insulating material. However, this condition is not absolutely necessary for satisfactory performance of the connector assembly 10, e.g., the sheath face 28 can confront without abutting the insulator 40. While it is not absolutely necessary for the cable face 28 to contact the insulator 40, it is indeed preferred because if the user strips away jacket, braid and dielectric to the correct length and does not fully insert the cable it is possible for the exposed center conductor. A gap between 0.005 and 0.01 inch would work just fine while a gap of 0.125 very well might not.

As thus assembled, the electrically conductive bushing 48, insulator 40, ring 54, and plug body 30 are locked together in electrical isolation from the signal conductor 22. Conductive screw 62 electrically connects the braided ground shield 18 through components 30, 54, 48 to the electrically conductive nut 56. The combination of conductive nut 56 connected to ground and signal conductor 22 centered within and projecting slightly from the nut 56, defines the “F” configuration of the plug for mating with an “F” jack.

1. An electronic signal connector for a coaxial cable, comprising:
an electrically conductive, hollow plug body having a main bore defining a connector longitudinal axis, with a back end for coaxially receiving a coaxial cable to be inserted toward a forward end of the plug body;
an insulator secured in the forward end of the plug body and having a base that closes the forward end of the main bore of the plug, and an axially extending central through bore;
an electrically conductive, open faced, internally threaded nut electrically connected to and extending forwardly of the plug body; and
electrically conductive means carried by the plug body for advancement into the main bore behind the insulator.

2. The connector of claim 1, including an electrically conductive nut bushing surrounding at least an axially extending forward portion of the insulator, and rigidly secured to the forward end of the plug body, with said nut carried rotatably and axially slidable on the nut bushing.

3. The connector of claim 1, including an electrically conductive nut bushing secured to and extending forward from the forward end of the plug body, with said nut carried on the nut bushing.

4. The connector of claim 2, wherein
the forward end of the plug body has lead and trailing counter bores;
the insulator has a base fixed in the trailing counter bore; and
an electrically conductive ring bushing is trapped between the leading counter bore of the plug body and nut bushing, thereby rigidly securing together the plug, ring bushing, nut bushing, and insulator.

5. The connector of claim 4, wherein
the nut has a radially inwardly directed, substantially annular projection;
the nut bushing has a substantially annular, radially outwardly directed projection that is located forward of and in sliding interference with the projection of nut, and an annular groove engaging the ring bushing.

6. The connector of claim 1, wherein the coaxial cable has as sheath including electrically conductive shielding, and a central signal conductor, and said means for advancement electrically connects the cable shielding to the plug body when the cable has been inserted in the main bore.

7. The connector of claim 6 in combination with said cable, wherein
the cable sheath is severed at a substantial right angle to define an annular front face and expose the signal conductor which extends forward of the sheathing;
the cable is inserted into the plug body toward the closed end of the main bore whereby the front face of the sheath confronts the insulator; and
the exposed signal conductor extends through the bore in the insulator and through the nut.

8. The connector of claim 7, wherein
the cable sheath has a jacket over a conductive ground shielding over an insulating dielectric material; and
the means for electrically connecting the cable shielding to the plug body comprises an electrically conductive screw threaded to the plug body and oriented transversely to the axis, said screw having a sharp leading edge that passes through the jacket and contacts the shielding.

9. The connector of claim 7, including an electrically conductive nut bushing surrounding at least an axially extending portion of the insulator, and rigidly secured to the forward end of the plug body, with said nut carried rotatably and axially slidable on the bushing; and wherein the plug body, nut bushing, and nut are in electrical contact with each other.

10. The connector of claim 9, wherein
the forward end of the plug body has lead and trailing counter bores;
the insulator has a base fixed in the trailing counter bore and a back surface in contact with face of the severed sheath; and
an electrically conductive ring bushing is trapped between the leading counter bore of the body and nut bushing, thereby rigidly securing together the plug, ring bushing, nut bushing, and insulator.

11. The connector of claim 10, wherein
the nut has a radially inwardly directed, substantially annular projection;
the bushing has a substantially annular, radially outwardly directed projection that is located forward of and in sliding interference with the projection on the nut, and an annular groove engaging the ring bushing.

12. The connector of claim 10, wherein
the ring bushing is press fit against the leading counter bore, thereby axially locking the insulator in the trailing counter bore; and
the nut bushing has a cylindrical trailing portion that is press fit between the ring bushing and the insulator, thereby locking together the nut bushing, insulator, ring bushing, and plug body.

13. The connector of claim 10, wherein
the cable sheath has a jacket over a conductive ground shielding over an insulating dielectric material; and
the means for electrically connecting the cable shielding to the plug body comprises an electrically conductive screw threaded to the plug body and oriented transversely to the axis, said screw having a sharp leading edge that passes through the jacket and contacts the shielding, wherein the screw provides a ground connection between the shielding and the plug, and retains the cable in the main bore by resisting rotation and axial forces on the cable.

14. The connector of claim 8, wherein the screw provides a ground connection between the shielding and the plug, and retains the cable in the main bore by resisting rotation and axial forces on the cable.

15. A method of joining a coaxial cable having a jacket, electrically conductive ground shielding, and a dielectric constituting a sheath surrounding a central solid signal conductor, to an to an F type plug connector, comprising:
(a) stripping the cable sheath uniformly through jacket, shielding, and dielectric, thereby defining an annular front face of the sheath and exposing the solid center conductor as projecting from the sheath face;
(b) selecting a substantially tubular, electrically conductive connector body having forward and back ends, with a conductive “F” type attachment nut at the forward end in conductive relation to the body;
(c) inserting the cable with exposed conductor into the connector body until the center conductor passes through the nut; and
(d) advancing a conductive fastener transversely through the connector body whereby the fastener cuts through the jacket and contacts the shielding, thereby providing a ground connection between the shielding and the connector body and securing the cable in the body.

16. A method of joining a coaxial cable having a jacket, braided shielding, and a dielectric constituting a sheath surrounding a central solid signal conductor, to an to an F type plug connector, comprising:
(a) stripping the cable sheath uniformly through jacket, shielding, and dielectric, thereby defining an annular front face of the sheath and exposing the solid center conductor as projecting from the sheath face;
(b) selecting a connector plug having a hollow plug body, an insulator secured in the forward end of the body and having a central bore, and an “F” type attachment nut carried forward of the insulator;
(c) inserting the cable with exposed conductor into the connector plug until the front face of the sheath confronts the insulator and the center conductor passes through the insulator and nut; and
(d) advancing a conductive member transversely through the plug body whereby the fastener cuts through the jacket and contacts the shielding, thereby providing a ground connection between the shielding and the plug.

17. The method of claim 16, wherein the insulator closes a forward end of the hollow body and step (c) includes inserting the cable until the front face abuts the insulator.

18. The method of claim 16, wherein
step (a) includes exposing the solid core for a length greater than the axial length of the insulator and nut; and
(e) at any time after step (b), trimming any portion of the exposed conductor that extends beyond a desired length relative to the front end of the nut.

19. The method of claim 16, wherein advancing the conductive member in step (d) includes advancing a metal screw through a threaded bore of the plug body.
